(19) United States
(12) Patent Application Publication
(10) Pub. No.: US 2024/0179556 A1
(43) Pub. Date: May 30, 2024

(54) INTERFERENCE COORDINATION AND MANAGEMENT IN WIRELESS COMMUNICATION

(71) Applicant: ZTE Corporation, Shenzhen (CN)

(72) Inventors: Xing LIU, Shenzhen (CN); Xianghui HAN, Shenzhen (CN); Xingguang WEI, Shenzhen (CN); Wei GOU, Shenzhen (CN); Jian LI, Shenzhen (CN)

(21) Appl. No.: 18/529,252

(22) Filed: Dec. 5, 2023

Related U.S. Application Data
(63) Continuation of application No. PCT/CN2022/088866, filed on Apr. 24, 2022.

(51) Int. Cl. H04W 24/10; H04L 5/00; H04W 24/08

(52) U.S. Cl. CPC H04W 24/10; H04L 5/0048; H04W 24/08

(57) ABSTRACT

Methods and systems for techniques for acquiring configuration information and performing interference coordination and management are disclosed. In an implementation, a method of wireless communication includes receiving, by a first network node, from a second network node, a configuration information, and performing, by the first network node, a measurement based on the configuration information.

### CROSS REFERENCE TO RELATED APPLICATIONS

This patent document is a continuation of and claims benefit of priority to International Patent Application No. PCT/CN2022/088866, filed on Apr. 24, 2022. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for acquiring configuration information and performing interference coordination and management.

In one aspect, a method of data communication is disclosed. The method includes receiving, by a first network node, from a second network node, a configuration information, and performing, by the first network node, a measurement based on the configuration information.

In another aspect, a method of data communication is disclosed. The method includes performing, by a first network node, a measurement based on a configuration information including at least one of a measurement reference signal configuration, a measurement parameter configuration, a measurement report configuration, or a frame structure, transmitting, by the first network node, to a second network node, a measurement report including a feedback information corresponding to the measurement according to the measurement report configuration, and performing, the first network node, an interference coordination based on the configuration information that is updated according to the measurement report.

In another aspect, a method of data communication is disclosed. The method includes determining, by a first network node, a transmission parameter configuration for a first direction transmission from the first network node based on a plurality of patterns of channel or signal transmission, and performing the first direction transmission according to the transmission parameter.

In another aspect, a method of data communication is disclosed. The method includes receiving, by a second network node, from a first network node, a feedback information corresponding to a measurement, and performing, by the second network node, a selection of time-frequency resources according to the feedback information.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows interferences between uplink and downlink transmissions at different frequency bands of an identical time resource and at the same frequency band of different cells.

FIG. 4 shows an example of factory automation scenario based on some embodiments of the disclosed technology.

FIG. 5 shows an example of a process for wireless communication based on some example embodiments of the disclosed technology.

FIG. 6 shows another example of a process for wireless communication based on some example embodiments of the disclosed technology.

FIG. 7 shows another example of a process for wireless communication based on some example embodiments of the disclosed technology.

FIG. 8 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC). Furthermore, full duplex is a requirement for 5G and further communication system.

In a wireless communication system, the time domain resource is split between downlink and uplink in time division duplex (TDD). Allocation of a limited time duration for the uplink in TDD would result in reduced coverage, increased latency and reduced capacity. As a possible enhancement on this limitation of the conventional TDD operation, it would be worth studying the feasibility of allowing the simultaneous existence of downlink and uplink (under a same or neighboring cell), such as full duplex, or more specifically, subband non-overlapping full duplex, or dynamic/flexible TDD.

In a full-duplex mode, when a base station (e.g., gNB) in a cell is interfered by another base station (e.g., gNB) in a different cell, there can be cross-link interference for the time-frequency resources with different attributes of frame structure between the different cells. Specifically, the downlink transmission of a gNB under a cell interferes with the uplink reception of another gNB under neighboring cell. Such an interference between the downlink and the uplink can be referred to as inter-gNB interference.

In recognition of the problems discussed above, the disclosed technology proposes various implementations of interference coordination and management schemes which may be used by embodiments to control such interferences more efficiently, thereby improving the performance of a full duplex transmission. One way to avoid cross-link interference is to determine a proper interference control mechanism by measuring the interference between different nodes. The disclosed technology can be implemented in some embodiments to provide reference signals and measure the interference between different network nodes.

In some scenarios, different resource attributes (e.g., uplink or downlink) may be configured by a neighboring cell for a same time frequency domain resource to meet the uplink and downlink transmission requirements of different cells.

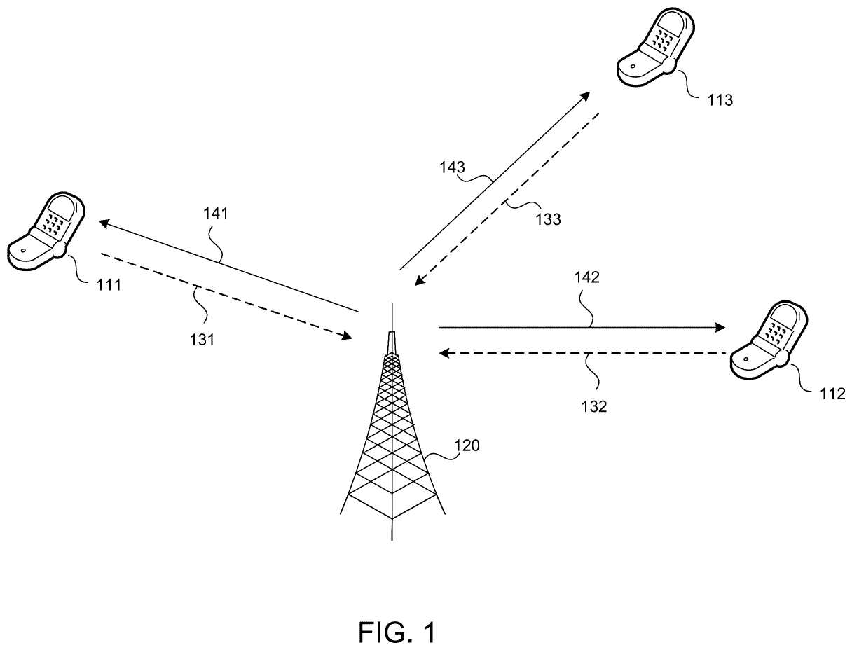

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

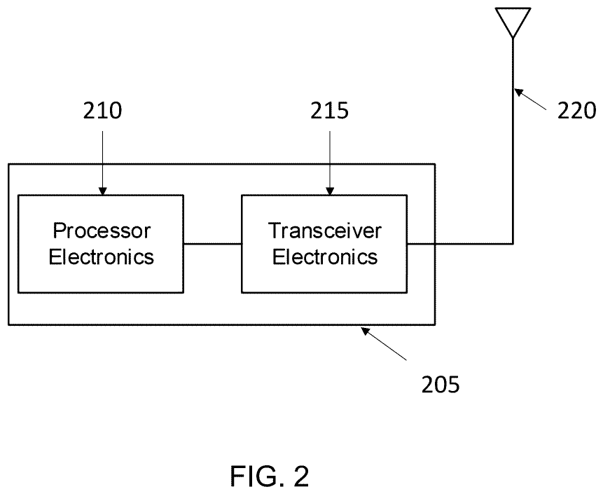

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

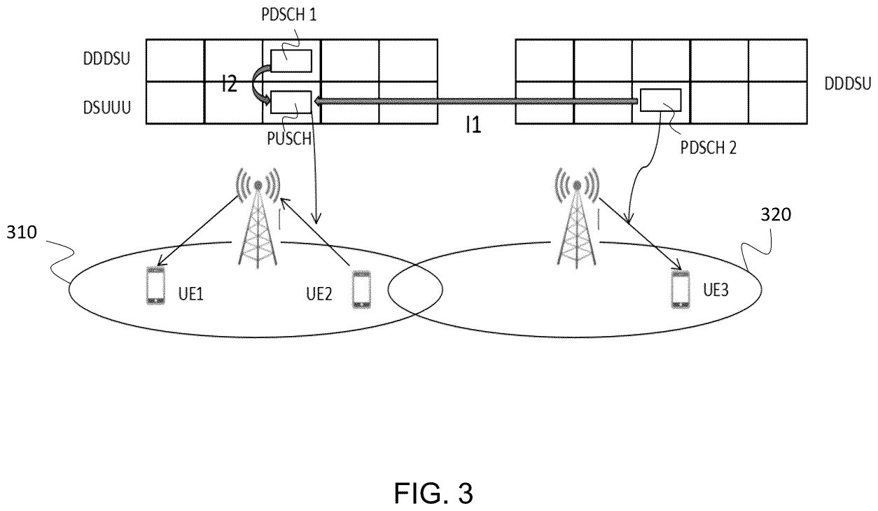

FIG. 3 shows interferences between uplink and downlink transmissions at different frequency bands of an identical time resource and at the same frequency band of different cells.

Referring to FIG. 3, for a cell 310 configured with subband full duplex, different transmission resource attributes are configured for different frequency resources during a certain time interval. As an example, one frequency resource is configured with “DDDSU,” and another frequency resource is “DSUUU,” where D represents “downlink,” U represents “uplink,” and S represents “flexible resource,” which can be updated according to dynamic scheduling or dynamic frame structure indication (e.g., SFI). During the middle three time intervals (e.g., slots 1-3 out of 5 slots (slots 0-4)) may have different attributes between different frequency resources. For different UEs, the base station can transmit PDSCH1 and receive PUSCH simultaneously. A neighboring cell 320 is configured without the frame structure of “DDDSU,” and there is a PDSCH2 scheduled in slot 2 overlapping with PUSCH. In this scenario, there will be two interference sources for the PUSCH transmission. One is gNB self-interference, that is, a downlink transmission from adjacent frequency (e.g., PDSCH1). The other is intra-frequency interference from adjacent gNB, that is, (downlink transmission from an adjacent gNB at the same frequency (e.g., PDSCH2).

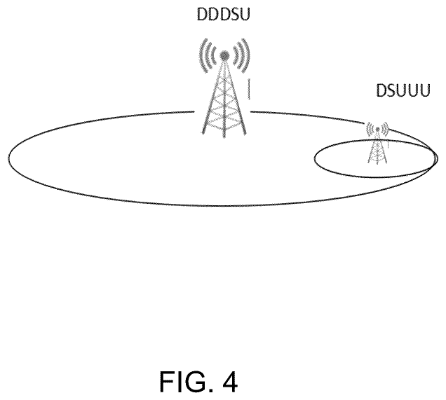

FIG. 4 shows an example of factory automation scenario based on some embodiments of the disclosed technology.

Under other scenarios, within the same time domain interval, adjacent base stations deployed at the same frequency can also be configured with different resource attributes (e.g., uplink or downlink), so as to meet the resource transmission requirements in specific scenarios. As an example, referring to FIG. 4, in the factory automation scenario, the factory area is covered by a micro station and there are a large number of uplink transmission requirements, and thus the frame structure is configured as “DSUUU.” However, the macro station overlapped with the factory area should consider the typical communication requirements. Thus, a higher downlink resource ratio is configured, e.g., “DDDSU.” Similarly, during the middle three time intervals (e.g., slots 1-3 out of 5 slots (slots 0-4)) may have transmissions with different attributes for a same time frequency domain resource between different base stations, e.g., a resource for a downlink transmission in the macro cell is overlapped with a resource for an uplink transmission in the micro cell. Similarly, the downlink transmission from a macro gNB will interfere with the uplink reception of the micro gNB during the time interval with different resource attributes.

The disclosed technology can be implemented in some embodiments to (1) transmit reference signals, (2) measure interferences that need to be defined, and (3) determine an appropriate interference coordination mechanism.

### Embodiment 1

The disclosed technology can be implemented in some embodiments to provide configuration information acquisition methods.

A first network node obtains configuration information from an operations, administration and maintenance (OAM) or from a second network node via an interface (e.g., Xn interface) between the first network node and the second network node.

The configuration information includes at least one of measurement reference signal configuration, measurement parameter configuration, measurement report configuration, or frame structure.

The measurement reference signal configuration includes at least one of the following information: reference signal (RS) type and resource of the RS.

The RS type can include at least one of synchronization signal block (SSB), channel state information reference signal (CSI-RS), demodulation reference signal (DMRS), sounding reference signal (SRS), or remote interference management reference signal (RIM-RS). In addition, the RS type is transmitted by a second network node. The resource configuration information of the RS includes at least one of a time domain resource of the RS, a frequency domain resource of the RS, a sequence of the RS, or a quasi co-location (QCL) source of the RS. In some examples, if two RSs QCLed with each other, it means they have a same large-scale transmission characteristic. Here, the large-scale transmission characteristic includes at least one of Doppler shift, Doppler spread, average delay, delay spread, or spatial Rx parameter.

In some implementations, the configuration information associated with SSB includes at least one of a period of SSB, an offset of SSB, an actually transmitted SSB, a cell identifier (ID) (e.g., a cell ID that is used to determine a sequence of SSB), or a frequency location of SSB (e.g., via ARFCN).

In some implementations, the offset is used for indicating the half frame in which the SSB located within a period. For example, assuming the period of SSB is 20 ms (e.g., 2 radio frame), there are four half frames within a period, and four offset values (0, 1, 2, 3) can be defined, where 0 represents the SSBs are located within the first half frame of each period, and 1 represents the SSBs are located within the second half frame of each period, 2 represents the SSBs are located within the third half frame of each period, and 3 represents the SSBs are located within the fourth half frame of each period. As another example, assuming the period of SSB is 10 ms (e.g., 1 radio frame), there are two half frames within a period, and two offset values can be defined (e.g., 0 and 1 indicate the SSB location). Similarly, 0 represents the SSBs are located within the first half frame of each period, and 1 represents the SSBs are located within the second half frame of each period.

There are two or more SSBs (assuming N SSBs) within a transmission period, and at least one of them will be actual transmitted. In this case, one or two bitmaps can be used for indicating SSBs that are actual transmitted. In one example, there is a bitmap with N bits for the indication. In another example, there are two bitmaps for the indication, and N SSBs are divided into M groups. A first bitmap with M bits is used for indicating which SSB groups contain the actually transmitted SSBs, and a second bitmap with N/M bits is used for indicating which SSBs are actually transmitted within the SSB groups indicated by the first bitmap.

In some implementations, the cell ID associated with the RS can be indicated about the sequence of the RS. For some of the RSs, the sequence is generated according to the cell ID. As such, the cell ID can be used for determining the sequence of the RS.

In some implementations, the measurement parameter configuration is used to indicate the targets to be measured, such as Reference Signal Received Power (RSRP), Received Signal Strength Indicator (RSSI), Reference Signal Received Quality (RSRQ), Signal to Interference plus Noise Ratio (SINR), and Channel Quality Indicator (CQI). For example, the measurement target may be the RSRP of the RS. In some examples, the first network node obtains RSRP for each RS via the measurement. The above measurement result can represent the power of RS, which can also represent the level or strength of the interference from the second network node to the first network node.

In some implementations, the measurement report configuration is used to indicate the conditions under which a measurement report is reported and the contents of the report. For example, a RSRP threshold is further configured, and the first network node reports the measurement result if the measured RSRP is higher than the RSRP threshold. In some examples, the measurement result may be reported from the first network node to the second network node or OAM periodically. In some examples, the measurement result may be reported only once from the first network node to the second network node or OAM.

In some implementations, the frame structure may be the frame structure of a cell of the second network node. The frame structure can be a semi-static frame structure configured by radio resource control (RRC) signaling, or a dynamic frame structure indicated via downlink control information (DCI), such as slot format indication (SFI).

In this way, the measurement configuration information can be provided effectively, and can be used for a subsequent interference measurement, coordination and management.

### Embodiment 2

The disclosed technology can be implemented in some embodiments to provide methods for performing measurement and feedback by the first network node.

In some implementations, the first network node performs the measurement according to at least one of the configuration information described in Embodiment 1. In addition, the measurement report may be generated according to the measurement report configuration.

In some implementations, the measurement report includes at least one of the following information:
one or more RS indices with the strongest power (or interference level or interference strength);
one or more RS indices with power (or interference level or interference strength) higher than a threshold;
one or more RS indices with the lowest power (or interference level or interference strength);
one or more RS indices with power (or interference level or interference strength) lower than the threshold;
one or more RS indices with power (or interference level or interference strength) lower than a first threshold and higher than a second threshold.
the power (or interference level or interference strength) corresponding to each reported RS;
one RS index list, in which RS indices in the list are sorted by power(or interference level or interference strength).
cell ID or node ID related with the reported RS index, i.e., ID of a cell or a node, which transmits the RS (for example, it is indicated that the transmission under the cell or by the node causes high interference to the first network node).
ID of a Cell or a node, which measures the RS.

The power (or interference level or interference strength) of RSs can be represented by one or more of RSRP, RSSI, RSRQ, SINR, CQI, etc.

According to the above measurement report, an interference source (identified by a cell ID or a base station ID or a set ID), and beam information (represented by RS index) regarding a high interference or a low interference as well as the corresponding interference strength can be provided for subsequent interference coordination and management operations.

In some embodiments, the feedback information from the first network node also includes information of resources (e.g., a resource pattern) allowed for high-interference transmissions in addition to the measurement report. In regard to the high-interference transmissions, the DMRS of the high-interference transmissions may be quasi-corelated (QCLed) or related with RS in the measurement report.

In some embodiments, the first network node can provide the feedback information to the second network node via an interface (e.g., Xn or X2 interface) between them. Alternatively, the first network node can transmit a reference signal (e.g., referred to as RS1) by carrying the feedback information. For example, at least one of the following methods can be used to carry feedback information on the RS1: the sequence of RS1 is initialized by at least part of the feedback information; the sequence of RS1 is scrambled by another sequence generated according to at least part of the feedback information; time domain resources of the RSI are related to at least part of the feedback information; and/or frequency domain resources of the RS1 are related to at least part of the feedback information.

In some embodiments, the first network node can provide the feedback information to its OAM.

In this way, the information can be obtained from the measurement effectively. In addition, the feedback information can be provided to an interference source or OAM for a subsequent interference coordination and management.

### Embodiment 3

The disclosed technology can be implemented in some embodiments to provide methods for performing interference coordination and management.

In some implementations, two or more patterns of channel or signal transmission are defined.

In some examples, the different patterns are defined as different resource patterns for DMRS transmission. In some examples, different time domain positions of DMRS are defined under different patterns. In some examples, different frequency domain positions of DMRS are defined under different patterns. In some examples, different sequences of DMRS may be used under different patterns. Here, the DMRS is related to either control channel or data channel. In some examples, the DMRS can be either uplink or downlink.

In some examples, the different patterns are defined as different transmission configurations of control channel (e.g., PDCCH, PUCCH). In some examples, different time domain positions of control channel are defined under different patterns. In some examples, different frequency domain positions of the control channel are defined under different patterns. In some examples, different CORESET (control resource set) configurations are defined for control channel transmission under different patterns. In some examples, different search space set configurations are defined for control channel transmission under different patterns. In some examples, different scrambling sequences are used for control channel transmission under different patterns. In some examples, the control channel can be either uplink or downlink.

In some examples, the different patterns are defined as different transmission configurations of data channel (e.g., PDSCH, PUSCH). In some examples, different time domain resource allocation (TDRA) tables are defined for data transmission under different patterns. In some examples, different modulation and coding scheme (MCS) tables are defined for data transmission under different patterns. In some examples, different redundancy versions (RVs) are used for data transmission under different patterns. In some examples, different repetition numbers are used for data transmission under different patterns. In some examples, different scrambling sequences are used for data transmission under different patterns.

In some examples, different power control parameters or transmission powers are defined for the transmission under different patterns.

In some embodiments, the second network node selects one pattern from the patterns for channel or signal transmission according to a relationship between DMRS of the transmission and RS in the feedback information described in Embodiment 2.

In some embodiments, the feedback information indicates one or more RS indices with the strongest power (or interference level or interference strength) or one or more RS indices with power (or interference level or interference strength) higher than the threshold. In addition, two patterns (e.g., pattern1, pattern2) are defined for channel or signal transmission. In this case, if the DMRS of the transmission is QCLed or related with the RS in the feedback information, pattern 1 will be selected. Otherwise, pattern 2 will be selected.

In some embodiments, pattern 1 is easier to reduce the interference to the uplink the first network node is receiving. For example, the downlink transmission resources of the second network node are at least partially orthogonal to the uplink receiving resources of the first network node. For example, the symbol of DMRS of downlink transmission from the second network node is different from the symbol of DMRS of uplink transmission to the first network node. Alternatively, a lower power than pattern 2 is used for the downlink transmission from the second network node.

In some embodiments, the feedback information indicates one or more RS indices with the lowest power (or interference level or interference strength) or one or more RS indices with power (or interference level or interference strength) lower than the threshold. In addition, two patterns (e.g., pattern1, pattern2) are defined for channel or signal transmission. In this case, if the DMRS of the transmission is QCLed or related with the RS in the feedback information, pattern 2 will be selected. Otherwise, pattern 1 will be selected. In some embodiments, pattern 1 is easier to reduce the interference to the uplink the first network node is receiving. For example, the downlink transmission resources of the second network node are at least partially orthogonal to the uplink receiving resources of the first network node. For example, the symbol of DMRS of downlink transmission from the second network node is different from the symbol of DMRS of uplink transmission to the first network node. Alternatively, a lower power than pattern 2 is used for the downlink transmission from the second network node.

In some embodiments, the feedback information indicates one or more RS indices with power (or interference level or interference strength) higher than the first threshold and one or more RS indices with power (or interference level or interference strength) lower than the first threshold and higher than the second threshold. In addition, three patterns (e.g., pattern1, pattern2, pattern 3) are defined for channel or signal transmission. In this case, if the DMRS of the transmission is QCLed or related with the RS with power (or interference level or interference strength) higher than the first threshold, pattern 1 will be selected. If the DMRS of the transmission is QCLed or related with the RS with power (or interference level or interference strength) lower than the first threshold and higher than the second threshold, pattern 2 will be selected. Otherwise, if the DMRS of the transmission is not QCLed or related with the RS in the feedback information, pattern 3 will be selected. In some embodiments, pattern 1 is easiest to reduce the interference to the uplink receiving of the first network node among all patterns. In addition, pattern 2 is easier to reduce the interference to the uplink the first network node is receiving, compared to pattern 3. For example, the allowed maximum power or power of the downlink transmission of the second network node under different patterns is P1, P2 and P3, respectively, where P1<P2<P3.

In this way, the transmission parameters can be determined according to the predefined patterns, by which interference can be coordinated and managed effectively.

### Embodiment 4

The disclosed technology can be implemented in some embodiments to provide methods for interference coordination and management.

In some implementations, two patterns (pattern 1 and pattern 2) of channel or signal transmission are defined. In addition, the specific definitions of different patterns are described in Embodiment 3.

In some implementations, the second network node selects one pattern from the patterns for channel or signal transmission according to at least one of the feedback information described in Embodiment 2.

In some embodiments, the feedback information indicates a cell ID or a node ID or a set ID corresponding to the transmission causing a high interference to the first network node. In this case, if the second network node or the cell under the second network node is indicated by the feedback information, pattern 1 will be selected, and otherwise, pattern 2 is selected. In some examples, the set ID can be related with a group of nodes or cells.

In some embodiments, pattern 1 is easier to reduce the interference to the uplink receiving of the first network node. For example, the downlink transmission resources of the second network node according to pattern 1 are at least partially orthogonal to the uplink receiving resources of the first network node. For example, the symbol of DMRS of downlink transmission from the second network node is different from the symbol of DMRS of uplink transmission to the first network node. Alternatively, a lower power than pattern 2 is used for the downlink transmission from the second network node.

In this way, the transmission parameters can be determined according to the predefined patterns, by which interference can be coordinated and managed effectively.

### Embodiment 5

The disclosed technology can be implemented in some embodiments to provide methods for interference coordination and management.

One or more pattern combinations (e.g., pattern combination 1, pattern combination 2, etc.) of channel or signal transmission are defined for both of the network nodes, e.g., the first network node (which preforms the measurement and feedback the measurement results) and the second network node (which transmits the measurement RS and receives the measurement results). Table 1 below shows the relationship between pattern combination index and pattern indices for the first network node and the second network node. In addition, patterns for different nodes are defined in a similar way as described in Embodiment 2.

In some embodiments, the pattern combination can be configured by OAM. Alternatively, the pattern combination is determined by one of the first and the second network node and transmitted to another network node.

TABLE 1

| | Pattern index | Pattern index |
|---|---|---|
| Pattern combination | for the first | for the second |
| index | network node | network node |
| 1 | 1 | 2 |
| 2 | 3 | 4 |
| . . . | . . . | . . . |

If the feedback information from the first network node includes the node ID or cell ID or set ID of the second network node, the first network node and the second network node will switch to a transmission pattern according to the definition of pattern combination.

For example, one pattern combination with pattern 1 for the first network node and pattern 2 for the second network node is defined. If the feedback information from the first network node includes the node ID or cell ID or set ID of the second network node, the first network node and the second network node will switch to the pattern combination for channel or signal transmission, repetitively. In some examples, the set ID can be related with a group of nodes or cells.

In some embodiments, the switching will be implemented according to a timeline, for example, a predefined time interval after the transmission of the feedback information.

In this way, the transmission parameters can be determined according to the predefined patterns, by which interference can be coordinated and managed effectively.

### Embodiment 6

The disclosed technology can be implemented in some embodiments to provide methods for interference coordination and management.

In some embodiments, the feedback information indicates one or more RS indices with the strongest power (or interference level or interference strength) or one or more RS indices with power (or interference level or interference strength) higher than the threshold. In this case, if the DMRS of a transmission from the second network node is QCLed or related with the RS indicated in the feedback information, this transmission is not allowed to be transmitted on specific time-frequency resources.

In some embodiments of the disclosed technology, the feedback information from first network node also includes information of resources allowed for high-interference transmissions in addition to the above information. Then, if the DMRS of a transmission from the second network node is QCLed or related with the RS indicated in the feedback information, this transmission is only allowed to be transmitted on resources that allowed for high interference transmission.

In some embodiments, the feedback information indicates one or more RS indices with the lowest power (or interference level or interference strength) or one or more RS indices with power (or interference level or interference strength) lower than the threshold. In this case, if the DMRS of a transmission from the second network node is not QCLed or related with the RS indicated in the feedback information, this transmission is not allowed to be transmitted on specific time-frequency resources. In other words, only the transmission with DMRS QCLed or related with the RS indicated in the feedback information can be transmitted on the specific time-frequency resource.

In some embodiments, the feedback information indicates one RS index list, in which RS indices in the list are sorted by power (or interference level or interference strength) from high to low. In this case, if the DMRS of a transmission from the second network node is QCLed or related with a RS belonging to the first N RS indicated in the feedback information, this transmission is not allowed to be transmitted on specific time-frequency resources.

In this way, the transmission parameters can be determined according to the predefined patterns, by which interference can be coordinated and managed effectively.

The disclosed technology can be implemented in some embodiments to provide methods for configuration information acquisition associated with interference measurement, measurement and feedback, interference coordination and management.

In some embodiments, the first network node obtains the configuration information from OAM or via an interface between different nodes. The configuration information includes at least one of measurement reference signal configuration, measurement parameter configuration, measurement report configuration, or frame structure.

In some embodiments, the first network node performs the measurement and feeds back the measurement report. The report includes at least one of one or more RS indices with the strongest power or with power higher than the threshold, one or more RS indices with the lowest power or with power lower than the threshold, the power corresponding to each reported RS, one RS index list, in which RS indices in the list are sorted by power, Cell ID or node ID associated with the reported RS index, ID of a cell or a node that measures the RS, resources (e.g., a resource pattern) allowed for high-interference transmissions.

The disclosed technology can be implemented in some embodiments to provide methods for interference coordination and management.

In some embodiments, two or more patterns of channel or signal transmission are defined, and the second network node selects one pattern according to the relationship between DMRS of the transmission and RS in the feedback information.

In some embodiments, two patterns of channel or signal transmission are defined. In addition, the second network node selects one pattern according to whether it has been indicated as a high interference cell or node.

In some embodiments, one or more pattern combinations of channel or signal transmission are defined for both the network nodes (the first network node and the second network node). A pattern combination is selected according to the feedback information.

In some embodiments, if the DMRS of a transmission from the second network node is QCLed or related with the RS indicated in the feedback information, the resource for this transmission may be limited (e.g., not allowed to be transmitted on specific time-frequency resources, or only can be transmitted on the resources allowed for high-interference transmissions).

As discussed above, the disclosed technology can be implemented in some embodiments to provide methods for configuration information acquisition related with interference measurement, measurement and feedback, interference coordination and management. In this way, the measurement configuration information can be provided and the information can be obtained from the measurement effectively, and a subsequent interference measurement, coordination and management can use the measurement configuration information and other information obtained from the measurement. In addition, according to the mechanism of interference coordination and management, interferences between different nodes can be reduced, improving the system efficiency.

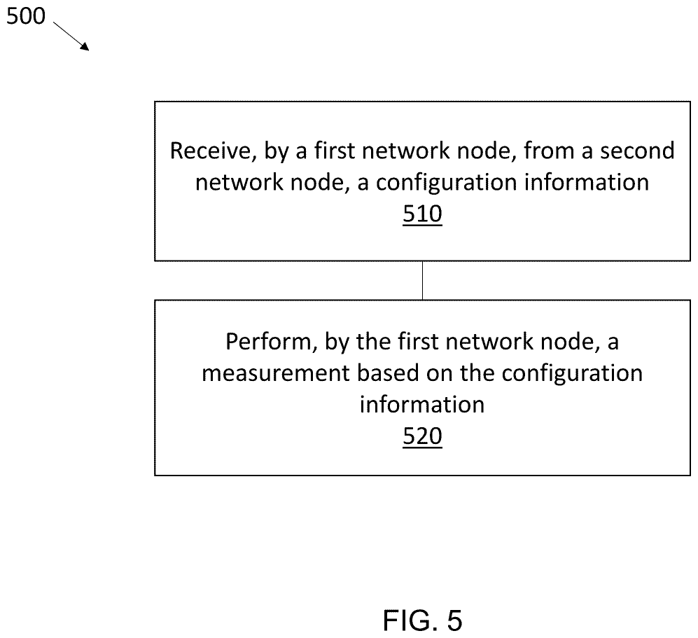

FIG. 5 shows an example of a process for wireless communication based on some example embodiments of the disclosed technology.

In some embodiments of the disclosed technology, a wireless communication method 500 includes, at 510, receiving, by a first network node, from a second network node, a configuration information, and, at 520, performing, by the first network node, a measurement based on the configuration information.

In some implementations, the configuration information includes at least one of a measurement reference signal configuration, a measurement parameter configuration, a measurement report configuration, or a frame structure.

In some implementations, the first and second network nodes include base stations.

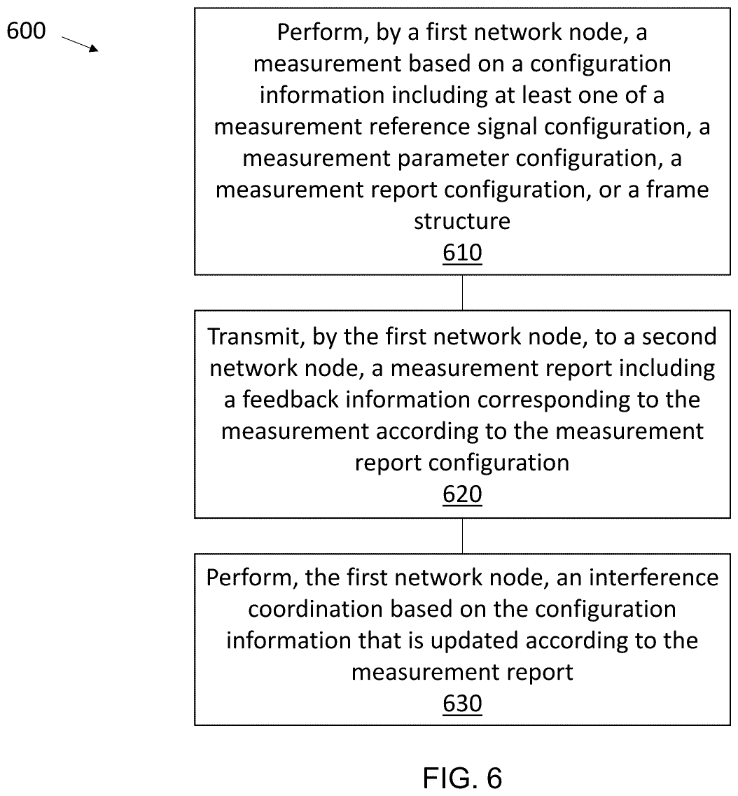

FIG. 6 shows an example of a process for wireless communication based on some example embodiments of the disclosed technology.

In some embodiments of the disclosed technology, a wireless communication method 600 includes, at 610, performing, by a first network node, a measurement based on a configuration information including at least one of a measurement reference signal configuration, a measurement parameter configuration, a measurement report configuration, or a frame structure, at 620, transmitting, by the first network node, to a second network node, a measurement report including a feedback information corresponding to the measurement according to the measurement report configuration, and, at 630, performing, the first network node, an interference coordination based on the configuration information that is updated according to the measurement report.

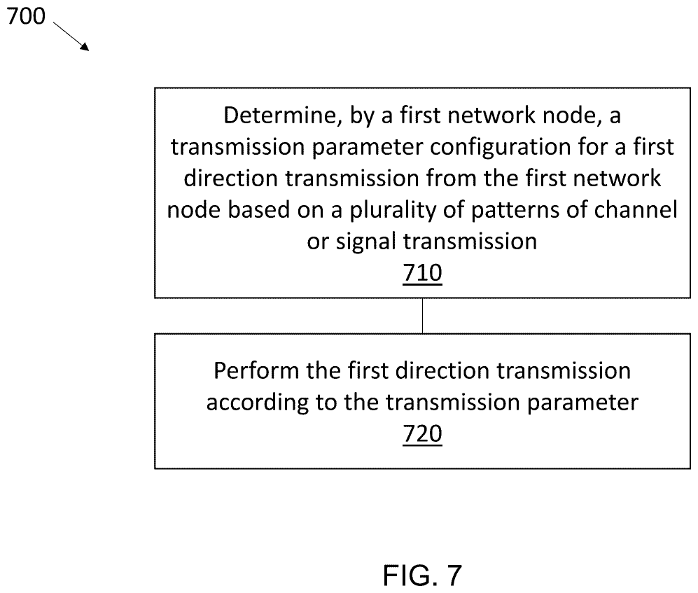

FIG. 7 shows an example of a process for wireless communication based on some example embodiments of the disclosed technology.

In some embodiments of the disclosed technology, a wireless communication method 700 includes, at 710, determining, by a first network node, a transmission parameter configuration for a first direction transmission from the first network node based on a plurality of patterns of channel or signal transmission, and, at 720, performing the first direction transmission according to the transmission parameter.

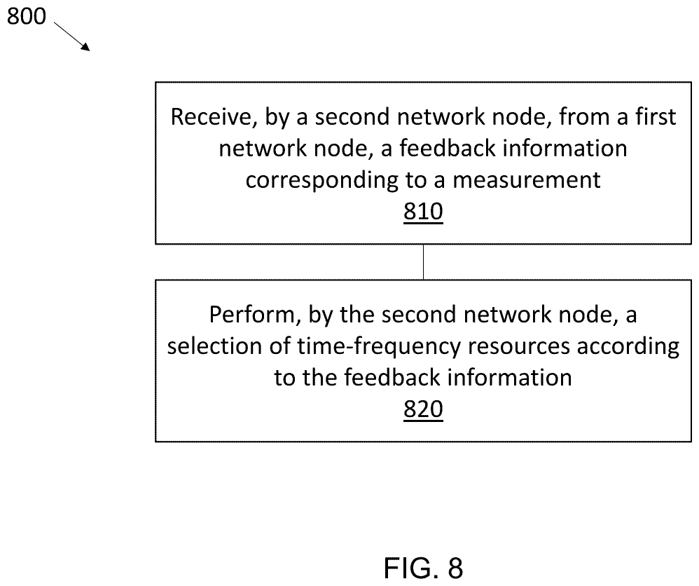

FIG. 8 shows an example of a process for wireless communication based on some example embodiments of the disclosed technology.

In some embodiments of the disclosed technology, a wireless communication method 800 includes, at 810, receiving, by a second network node, from a first network node, a feedback information corresponding to a measurement, and, at 820, performing, by the second network node, a selection of time-frequency resources according to the feedback information.

It will be appreciated that the present document discloses techniques that can be embodied in various embodiments to provide interference coordination and management schemes in wireless networks, thereby improving the performance of a full duplex transmission.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

In some embodiments, a method of wireless communication includes receiving, by a first network node, from a second network node, a configuration information; and performing, by the first network node, a measurement based on the configuration information.

In some embodiments, the configuration information includes at least one of a measurement reference signal configuration, a measurement parameter configuration, a measurement report configuration, or a frame structure.

In some embodiments, the measurement reference signal configuration includes at least one of reference signal (RS) type information or RS resource information.

In some embodiments, the RS type information includes at least one of synchronization signal block (SSB), channel state information reference signal (CSI-RS), demodulation reference signal (DMRS), sounding reference signal (SRS), or remote interference management reference signal (RIM-RS), wherein resource information of the SSB includes at least one of a period of SSB, an offset of SSB, an actually transmitted SSB, a cell identifier (ID) of a cell associated with the second network node, or a frequency location of SSB.

In some embodiments, the resource information of RS includes at least one of time domain resource of RS, frequency domain resource of RS, sequence of RS, or quasi co-location (QCL) source of RS.

In some embodiments, the measurement parameter configuration indicates a measurement target including at least one of reference signal received power (RSRP), received signal strength indicator (RSSI), reference signal received quality (RSRQ), signal to interference plus noise ratio (SINR), or channel quality indicator (CQI).

In some embodiments, the measurement report configuration indicates conditions for a measurement report to be reported and contents of a measurement report.

In some embodiments, the measurement report configuration includes a threshold value, and wherein the first network node transmits the measurement report in a case that a measured result is higher than the threshold value.

In some embodiments, the first network node transmits the measurement report periodically.

In some embodiments, the frame structure corresponds to a frame structure of a cell of the second network node.

In some embodiments, the frame structure includes at least one of a semi-static frame structure configured by radio resource control (RRC) signaling, or a dynamic frame structure indicated by downlink control information (DCI).

In some embodiments, the receiving of the configuration information includes receiving a configuration information from an operations, administration and maintenance (OAM) function.

In some embodiments, another method of wireless communication includes: performing, by a first network node, a measurement based on a configuration information including at least one of a measurement reference signal configuration, a measurement parameter configuration, a measurement report configuration, or a frame structure; transmitting, by the first network node, to a second network node, a measurement report including a feedback information corresponding to the measurement according to the measurement report configuration; and performing, the first network node, an interference coordination based on the configuration information that is updated according to the measurement report.

In some embodiments, the measurement report includes at least one of: one or more RS indices corresponding to a strongest power or interference level or interference strength; one or more RS indices corresponding to a power or interference level or interference strength that is higher than a threshold value; one or more RS indices corresponding to a lowest power or interference level or interference strength; one or more RS indices corresponding to a power or interference level or interference strength that is lower than the threshold value; one or more RS indices corresponding to a power or interference level or interference strength that is lower than a first threshold value and higher than a second threshold value; a power or interference level or interference strength corresponding to each reported RS; one RS index list that includes RS indices sorted by a power or interference level or interference strength; a cell ID or node ID associated with a reported RS index; or a cell or a node that measures RS.

In some embodiments, the power or interference level or interference strength of the one or more RS indices is indicated by at least one of RSRP, RSSI, RSRQ, SINR, or CQI.

In some embodiments, the feedback information includes a resource pattern for high-interference transmissions.

In some embodiments, the feedback information is carried by a first reference signal by performing a first method, wherein the first method includes at least one of: initializing a sequence of the first reference signal by the feedback information; scrambling the sequence of the first reference signal by another sequence generated according to the feedback information; relating time domain resources of the first reference signal to the feedback information; or relating frequency domain resources of the first reference signal to the feedback information.

In some embodiments, another method of wireless communication includes: determining, by a first network node, a transmission parameter configuration for a first direction transmission from the first network node based on a plurality of patterns of channel or signal transmission; and performing the first direction transmission according to the transmission parameter.

In some embodiments, the performing of the first direction transmission includes adjusting the first direction transmission.

In some embodiments, the plurality of patterns includes at least one of time domain positions or frequency domain positions of a demodulation reference signal (DMRS).

In some embodiments, the plurality of patterns includes at least one of: time domain positions or frequency domain positions of a control channel; different control resource set configurations; different search space set configurations; or different scrambling sequences.

In some embodiments, the plurality of patterns includes at least one of: time domain resource allocation (TDRA) tables for data transmission; modulation and coding scheme (MCS) tables for data transmission; redundancy versions (RVs) for data transmission; repetition numbers for data transmission; or scrambling sequences for data transmission.

In some embodiments, the plurality of patterns includes transmission powers for data transmission.

In some embodiments, a second network node selects one of the plurality of patterns according to a relationship between DMRS of the first direction transmission and a reference signal in a feedback information transmitted from the first network node to the second network node to indicate a measurement of an interference between the first network node and the second network node.

In some embodiments, the feedback information indicates one or more RS indices corresponding to a strongest power or interference level or interference strength, or one or more RS indices corresponding to a power or interference level or interference strength higher than a threshold value.

In some embodiments, the plurality of patterns includes a first pattern and a second pattern, wherein a second network node selects one of the first and second patterns according to a feedback information from the first network node corresponding to a measurement.

In some embodiments, the feedback information includes a resource pattern for a transmission that exceeds a threshold.

In some embodiments, the feedback information is carried by a first reference signal by performing a first method, wherein the first method includes at least one of: initializing a sequence of the first reference signal by the feedback information; scrambling the sequence of the first reference signal by another sequence generated according to the feedback information; relating time domain resources of the first reference signal to the feedback information; or relating frequency domain resources of the first reference signal to the feedback information.

In some embodiments, the feedback information indicates a cell ID or a node ID corresponding to a transmission that causes, to the first network node, an interference that exceeds a threshold interference.

In some embodiments, the first network node performs a measurement, and the second network node receives a measurement result from the first network node, wherein the plurality of patterns includes one or more combinations of the patterns defined for the first and second network nodes, wherein one of the plurality of patterns is selected according to a feedback information corresponding to the measurement.

In some embodiments, in a case that the feedback information from the first network node includes a cell ID or a node ID of the second network node, the first network node and the second network node switch to a transmission pattern according to the one or more combinations of the patterns defined for the first and second network nodes.

In some embodiments, another method of wireless communication includes: receiving, by a second network node, from a first network node, a feedback information corresponding to a measurement; and performing, by the second network node, a selection of time-frequency resources according to the feedback information.

In some embodiments, the feedback information indicates one or more reference signal indices corresponding to a strongest power or interference level or interference strength, or one or more reference signal indices corresponding to a power or interference level or interference strength higher than a threshold value, wherein, in a case that a demodulation reference signal (DMRS) of a first transmission from the second network node is quasi-corelated with a reference signal indicated in the feedback information, the selection of time-frequency resources includes disallowing the first transmission on the time-frequency resources.

In some embodiments, the feedback information includes information of resources for high-interference transmissions, and wherein the first transmission is only allowed to be transmitted on the resources for high-interference transmissions.

In some embodiments, the feedback information indicates one or more reference signal indices corresponding to a lowest power or interference level or interference strength, or one or more reference signal indices corresponding to a power or interference level or interference strength lower than the threshold value, wherein, in a case that a DMRS of a first transmission from the second network node is not quasi-corelated with a reference signal indicated in the feedback information, the selection of time-frequency resources includes disallowing the first transmission on the time-frequency resources.

In some embodiments, the feedback information indicates one reference signal index list that includes reference signal indices sorted by power or interference level or interference strength, wherein in a case that the DMRS of the first transmission from the second network node is quasi-corelated with a reference signal belonging to a set of first reference signal indices, the selection of time-frequency resources includes disallowing the first transmission on the time-frequency resources.

In some embodiments, the interference includes an interference between uplink and downlink transmissions by the first network node at different frequency bands of an identical time resource.

In some embodiments, the interference includes an interference between an uplink transmission by the first network node and a downlink transmission by the second network node at a same frequency band of different cells.

In some embodiments the first and second network nodes include base stations.

In some embodiments, an apparatus for wireless communication includes a processor that is configured to carry out the method of any of clauses discussed above.

In some embodiments, a non-transitory computer readable medium having code stored thereon, the code when executed by a processor, causing the processor to implement a method recited in any of clauses discussed above.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
receiving, by a first network node, from a second network node, a configuration information; and
performing, by the first network node, a measurement based on the configuration information,
wherein the configuration information includes at least one of a measurement reference signal configuration, a measurement parameter configuration, a measurement report configuration, or a frame structure,
wherein the measurement reference signal configuration includes at least one of reference signal (RS) type information or RS resource information,
wherein the measurement parameter configuration indicates a measurement target,
wherein the measurement report configuration indicates conditions for a measurement report to be reported and contents of a measurement report,
wherein the frame structure corresponds to a frame structure of a cell of the second network node.

2-3. (canceled)

4. The method of claim 1, wherein the RS type information includes at least one of synchronization signal block (SSB), channel state information reference signal (CSI-RS), demodulation reference signal (DMRS), sounding reference signal (SRS), or remote interference management reference signal (RIM-RS), wherein resource information of the SSB includes at least one of a period of SSB, an offset of SSB, an actually transmitted SSB, a cell identifier (ID) of a cell associated with the second network node, or a frequency location of SSB.

5. The method of claim 1, wherein the resource information of RS includes at least one of time domain resource of RS, frequency domain resource of RS, sequence of RS, or quasi co-location (QCL) source of RS.

6. The method of claim 1, wherein the measurement target includes at least one of reference signal received power (RSRP), received signal strength indicator (RSSI), reference signal received quality (RSRQ), signal to interference plus noise ratio (SINR), or channel quality indicator (CQI).

7. (canceled)

8. The method of claim 1, wherein the measurement report configuration includes a threshold value, and wherein the first network node transmits the measurement report in a case that a measured result is higher than the threshold value.

9. The method of claim 1, wherein the first network node transmits the measurement report periodically.

10. (canceled)

11. The method of claim 1, wherein the frame structure includes at least one of a semi-static frame structure configured by radio resource control (RRC) signaling, or a dynamic frame structure indicated by downlink control information (DCI).

12. The method of claim 1, wherein the receiving of the configuration information includes receiving a configuration information from an operations, administration and maintenance (OAM) function.

13. A method of wireless communication, comprising:
performing, by a first network node, a measurement based on a configuration information including at least one of a measurement reference signal configuration, a measurement parameter configuration, a measurement report configuration, or a frame structure;
transmitting, by the first network node, to a second network node, a measurement report including a feedback information corresponding to the measurement according to the measurement report configuration; and
performing, the first network node, an interference coordination based on the configuration information that is updated according to the measurement report.

14. The method of claim 13, wherein the measurement report includes at least one of:
one or more RS indices corresponding to a strongest power or interference level or interference strength;
one or more RS indices corresponding to a power or interference level or interference strength that is higher than a threshold value;
one or more RS indices corresponding to a lowest power or interference level or interference strength;
one or more RS indices corresponding to a power or interference level or interference strength that is lower than the threshold value;
one or more RS indices corresponding to a power or interference level or interference strength that is lower than a first threshold value and higher than a second threshold value;
a power or interference level or interference strength corresponding to each reported RS;
one RS index list that includes RS indices sorted by a power or interference level or interference strength;
a cell ID or node ID associated with a reported RS index; or
a cell or a node that measures RS.

15. (canceled)

16. The method of claim 13, wherein the feedback information includes a resource pattern for high-interference transmissions.

17. The method of claim 13, wherein the feedback information is carried by a first reference signal by performing a first method, wherein the first method includes at least one of: initializing a sequence of the first reference signal by the feedback information; scrambling the sequence of the first reference signal by another sequence generated according to the feedback information; relating time domain resources of the first reference signal to the feedback information; or relating frequency domain resources of the first reference signal to the feedback information.

18. A method of wireless communication, comprising:
determining, by a first network node, a transmission parameter configuration for a first direction transmission from the first network node based on a plurality of patterns of channel or signal transmission; and
performing the first direction transmission according to the transmission parameter,
wherein the plurality of patterns includes at least one of: time domain positions or frequency domain positions of a demodulation reference signal (DMRS); time domain positions or frequency domain positions of a control channel; different control resource set configurations; different search space set configurations; or different scrambling sequences.

19. The method of claim 18, wherein the performing of the first direction transmission includes adjusting the first direction transmission.

20-21. (canceled)

22. The method of claim 18, wherein the plurality of patterns includes at least one of: time domain resource allocation (TDRA) tables for data transmission; modulation and coding scheme (MCS) tables for data transmission; redundancy versions (RVs) for data transmission; repetition numbers for data transmission; or scrambling sequences for data transmission.

23. The method of claim 18, wherein the plurality of patterns includes transmission powers for data transmission.

24. The method of claim 18, wherein a second network node selects one of the plurality of patterns according to a relationship between DMRS of the first direction transmission and a reference signal in a feedback information transmitted from the first network node to the second network node to indicate a measurement of an interference between the first network node and the second network node.

25. (canceled)

26. The method of claim 18, wherein the plurality of patterns includes a first pattern and a second pattern, wherein a second network node selects one of the first and second patterns according to a feedback information from the first network node corresponding to a measurement.

27-29. (canceled)

30. The method of claim 18, wherein the first network node performs a measurement, and a second network node receives a measurement result from the first network node, wherein the plurality of patterns includes one or more combinations of the patterns defined for the first and second network nodes, wherein one of the plurality of patterns is selected according to a feedback information corresponding to the measurement.

31-38. (canceled)

39. The method of claim 1, wherein the first and second network nodes include base stations.

40-41. (canceled)
